(19) United States
(12) Patent Application Publication
(10) Pub. No.: US 2011/0304147 A1
(43) Pub. Date: Dec. 15, 2011

(54) Water Cycle Generating System

(76) Inventor: Fu-Hung Ho, Taichung (TW)

(21) Appl. No.: 12/814,528

(22) Filed: Jun. 14, 2010

(51) Int. Cl. F03B 13/06; F03B 17/04

(52) U.S. Cl. 290/54; 415/916

(57) ABSTRACT

A generating system includes a base, a first water storage tank mounted on a lower portion of the base, a water tower mounted on an upper portion of the base, at least one generator unit mounted on the base and disposed between the water tower and the first water storage tank, a penstock unit connected between the water tower and the first water storage tank and passing through the generator unit, and at least one water raising device connected between the first water storage tank and the water tower to raise water from the first water storage tank to the water tower. Thus, the water raising device can pump the water from the first water storage tank into the water tower without needing any electric power so as to save the cost largely.

### BACKGROUND OF THE INVENTION

1. Field of the Invention

The present invention relates to a generating system and, more particularly, to a water cycle generating system.

2. Description of the Related Art

A conventional generating system comprises a chain, a plurality of catch boards, a large gear and a generator unit. The catch boards are mounted in a water pipe to catch water to increase the water weight to drive the large gear which is rotated to drive the generator unit so as to produce an electric power. However, the generating system has a very complicated construction, thereby greatly increasing its cost of fabrication and causing inconvenience in maintenance.

### BRIEF SUMMARY OF THE INVENTION

In accordance with the present invention, there is provided a generating system, comprising a base, a first water storage tank mounted on a lower portion of the base, a water tower mounted on an upper portion of the base, at least one generator unit mounted on the base and disposed between the water tower and the first water storage tank, a penstock unit connected between the water tower and the first water storage tank and passing through the generator unit to introduce water from the water tower through the generator unit into the first water storage tank, and at least one water raising device mounted on a side of the base and connected between the first water storage tank and the water tower to raise water from the first water storage tank to the water tower.

According to the primary advantage of the present invention, the pressure tank produces a high air pressure by the successive pivotal action of the air inlet valve, and the high air pressure in the pressure tank thrusts the water into the water tower so that the water raising device can pump the water from the first water storage tank into the water tower without needing any electric power so as to save the cost largely.

According to another advantage of the present invention, the water raising device pumps the water from the first water storage tank into the water tower, and the water in the water tower initially passes through the generator unit to generate an electric power and then directly falls down into the first water storage tank so that the generating system forms a water cycle to generate an electric power in a cyclic manner.

According to a further advantage of the present invention, the water drained from the water raising device is driven by the water return device and can be returned into the first water storage tank.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a generating system in accordance with the preferred embodiment of the present invention.

FIG. 2 is a top view of the generating system as shown in FIG. 1.

FIG. 3 is a partially enlarged cross-sectional view of the generating system as shown in FIG. 1.

FIG. 4 is a schematic operational view of the generating system as shown in FIG. 3.

FIG. 5 is a partially enlarged cross-sectional view of the generating system as shown in FIG. 1.

FIG. 6 is a side cross-sectional view of the generating system as shown in FIG. 5.

FIG. 7 is a partially enlarged cross-sectional view of the generating system as shown in FIG. 1.

FIG. 8 is another side cross-sectional view of the generating system as shown in FIG. 5.

### DETAILED DESCRIPTION OF THE INVENTION

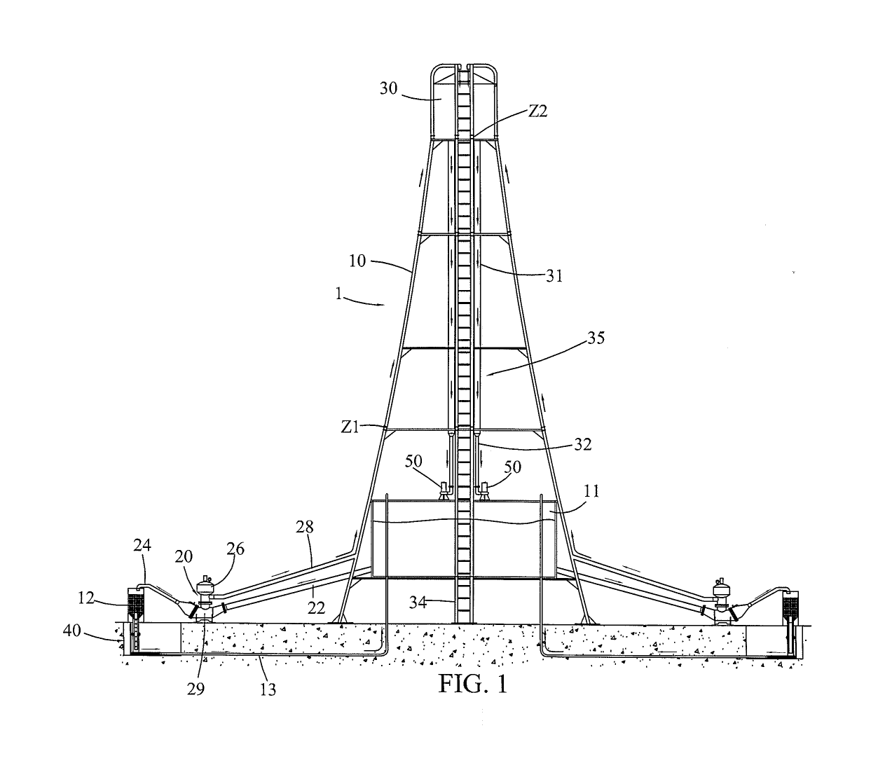

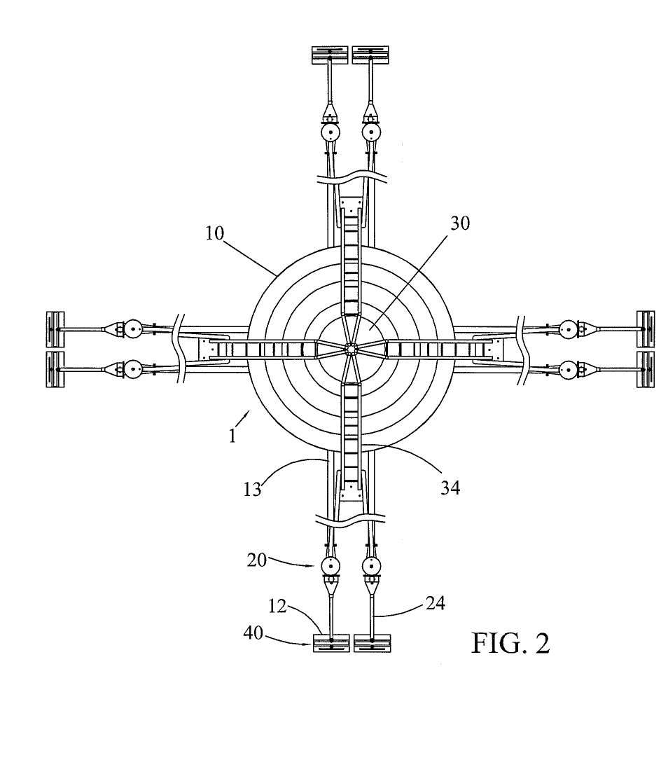

Referring to the drawings and initially to FIGS. 1-7, a generating system in accordance with the preferred embodiment of the present invention comprises a base 1, a first water storage tank 11 mounted on a lower portion of the base 1, a water tower 30 mounted on an upper portion of the base 1, at least one generator unit 50 mounted on the base 1 and disposed between the water tower 30 and the first water storage tank 11, a penstock unit 35 connected between the water tower 30 and the first water storage tank 11 and passing through the generator unit 50 to introduce water from the water tower 30 through the generator unit 50 into the first water storage tank 11, and at least one water raising device 20 mounted on a side of the base 1 and connected between the first water storage tank 11 and the water tower 30 to raise water from the first water storage tank 11 to the water tower 30.

The water raising device 20 includes a housing 29 having an inner portion formed with a receiving chamber 21, a water inlet pipe 22 having a first end mounted on a first side of the housing 29 and connected to the receiving chamber 21 of the housing 29 and a second end connected to the first water storage tank 11, a water outlet pipe 24 mounted on a second side of the housing 29 and connected to the receiving chamber 21 of the housing 29, an air inlet port 241 mounted on a periphery of the water outlet pipe 24 to introduce ambient air into the water outlet pipe 24, an air inlet valve 23 pivotally mounted in the second side of the housing 29 and located between the water outlet pipe 24 and the receiving chamber 21 of the housing 29 to close a connection between the water outlet pipe 24 and the receiving chamber 21 of the housing 29, a weight 25 mounted on the air inlet valve 23 to move the air inlet valve relative to the housing 29 by a gravity of the weight 25 so as to open the connection between the water outlet pipe 24 and the receiving chamber 21 of the housing 29 and to introduce the air from the water outlet pipe 24 into the receiving chamber 21 of the housing 29, a pressure tank 26 mounted on a mediate portion of the housing 29 and connected to the receiving chamber 21 of the housing 29, a water conveyor pipe 28 having a first end connected to the pressure tank 26 and a second end connected to the water tower 30 to convey water from the pressure tank 26 to the water tower 30, a water pump valve 27 movably mounted in the pressure tank 26 and movable between the pressure tank 26 and the housing 29 to open a connection between the pressure tank 26 and the receiving chamber 21 of the housing 29, and a restoring spring “S” biased between the water pump valve 27 and the housing 29 to close the water pump valve 27 and to close the connection between the pressure tank 26 and the receiving chamber 21 of the housing 29.

The pressure tank 26 of the water raising device 20 is disposed between the water inlet pipe 22 and the air inlet valve 23. The air inlet valve 23 of the water raising device 20 is disposed between the pressure tank 26 and the water outlet pipe 24. The air inlet port 241 of the water raising device 20 is disposed between the air inlet valve 23 and the water outlet pipe 24. The water pump valve 27 of the water raising device 20 is disposed between the receiving chamber 21 of the housing 29 and the water conveyor pipe 28. The water outlet pipe 24 of the water raising device 20 has a first end mounted on the second side of the housing 29 and connected to the receiving chamber 21 of the housing 29.

The base 1 includes a plurality of delivery pipes 10 each having an upper end connected to the water tower 30 and a lower end connected to the water conveyor pipe 28 of the water raising device 20, and a plurality of check valves “Z1” mounted on the delivery pipes 10 to prevent water in the water tower 30 from flowing back into the water conveyor pipe 28 of the water raising device 20.

The generating system further comprises at least one second water storage tank 12 located under a second end of the water outlet pipe 24 of the water raising device 20 to receive water from the water outlet pipe 24 of the water raising device 20, at least one water return pipe 13 connected between the second water storage tank 12 and the first water storage tank 11 to return water from the second water storage tank 12 to the first water storage tank 11, and at least one water return device 40 mounted on the water return pipe 13 to pump water from the water return pipe 13 to the first water storage tank 11. The water return pipe 13 and the water return device 40 are disposed under the second water storage tank 12.

The water return device 40 is located under the second water storage tank 12 and includes a water mill 41 rotatably mounted between the second water storage tank 12 and the water return pipe 13, a screw propeller 42 rotatably mounted in the water return pipe 13 and rotated by the water mill 41 to push the water in the water return pipe 13 toward the first water storage tank 11, a larger sprocket 43 secured on the water mill 41 to rotate in concert with the water mill 41, a smaller sprocket 44 secured on the screw propeller 42 to rotate the screw propeller 42, and a transmission chain 45 mounted between the larger sprocket 43 and the smaller sprocket 44 so that the smaller sprocket 44 is rotated by the larger sprocket 43. The water mill 41 of the water return device 40 has a periphery provided with a plurality of semi-circular catch plates 46 that are movable to align with the second water storage tank 12. The smaller sprocket 44 of the water return device 40 has a diameter smaller than that of the larger sprocket 43. The screw propeller 42 of the water return device 40 is located under the water mill 41.

The penstock unit 35 is located under the water tower 30 and above the generator unit 50 and the first water storage tank 11, and the generator unit 50 is located above the first water storage tank 11. The penstock unit 35 includes at least one larger pipe 31 having an upper end connected to the water tower 30, at least one smaller pipe 32 having an upper end connected to a lower end of the larger pipe 31 and a lower end passing through the generator unit 50 and connected to the first water storage tank 11, and a booster screw 33 rotatably mounted in the smaller pipe 32 to increase pressure of water from the larger pipe 31 into the smaller pipe 32. The smaller pipe 32 of the penstock unit 35 has a diameter smaller than that of the larger pipe 31. The booster screw 33 of the penstock unit 35 is disposed between the larger pipe 31 and the smaller pipe 32.

The generating system further comprises a ladder 34 resting on the water tower 30 to facilitate maintenance of the water tower 30. Preferably, the larger pipe 31 and the smaller pipe 32 of the penstock unit 35 construct a part of the ladder 34 to decrease the cost of fabrication of the generating system.

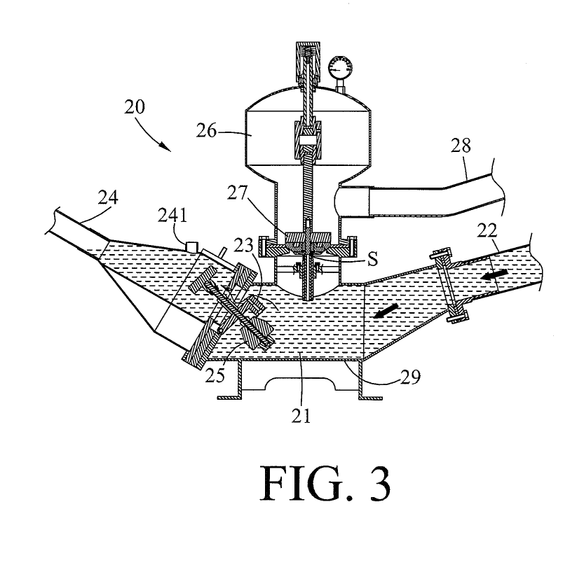

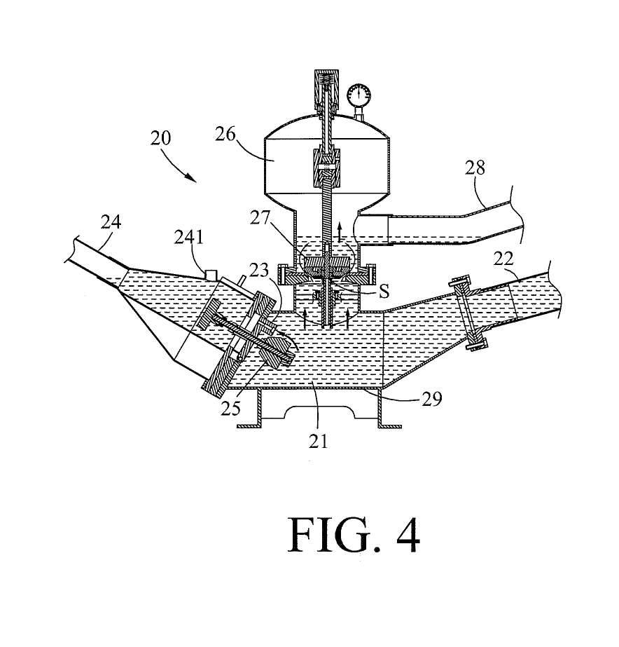

In operation, the air inlet valve 23 is pivoted downward and opened by the gravity of the weight 25 as shown in FIG. 3 to open the connection between the water outlet pipe 24 and the receiving chamber 21 so that the ambient air is introduced through the air inlet port 241, the water outlet pipe 24 and the air inlet valve 23 into the receiving chamber 21. Then, the water in the first water storage tank 11 is delivered through the water inlet pipe 22 into the receiving chamber 21 to push the air inlet valve 23 upward so that the air inlet valve 23 is closed as shown in FIG. 4 to close the connection between the water outlet pipe 24 and the receiving chamber 21. At this time, the air in the receiving chamber 21 is compressed by the pivotal action of the air inlet valve 23 to flow through the water pump valve 27 into the pressure tank 26. In such a manner, when the water in the first water storage tank 11 is delivered into the receiving chamber 21 successively, the air inlet valve 23 is closed by the water pressure in the receiving chamber 21 as shown in FIG. 4 and is opened by the gravity of the weight 25 as shown in FIG. 3 so that the air inlet valve 23 is pivoted successively to introduce the air from the water outlet pipe 24 into the receiving chamber 21 and to force the air from the receiving chamber 21 into the pressure tank 26 intermittently. Thus, the air in the pressure tank 26 is accumulated and compressed gradually by the successive pivotal action of the air inlet valve 23 so that the pressure tank 26 stores a very high pressure which can thrust the water from the receiving chamber 21 through the pressure tank 26 into the water conveyor pipe 28. Finally, the water is gradually pressed by the high air pressure in the pressure tank 26 to flow through the water conveyor pipe 28 and the delivery pipes 10 into the water tower 30. Thus, the pressure tank 26 produces a high air pressure by the successive pivotal action of the air inlet valve 23, and the high air pressure in the pressure tank 26 thrusts the water into the water tower 30.

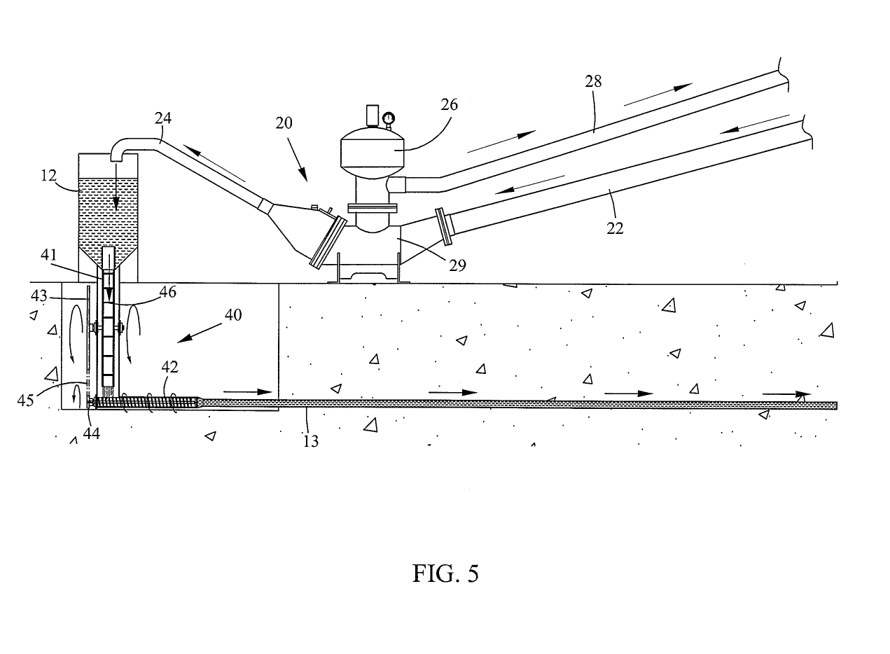

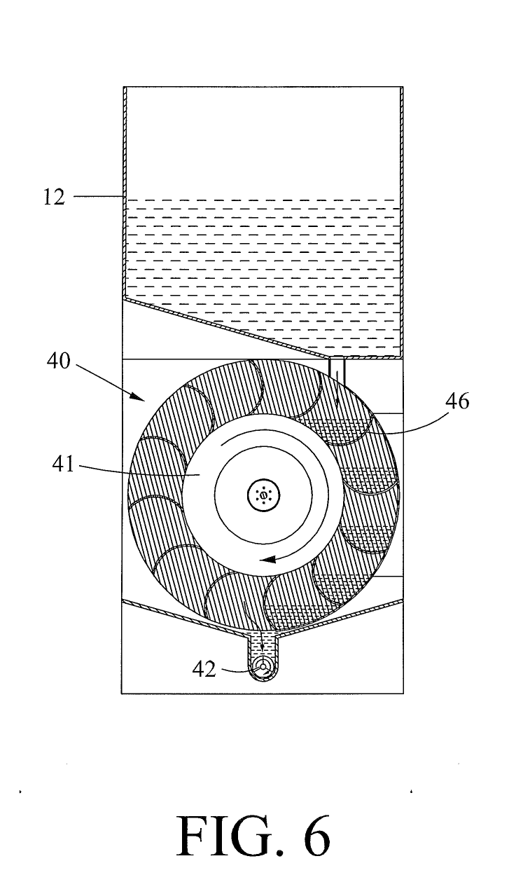

In addition, the water flowing out of the air inlet valve 23 is delivered through the water outlet pipe 24 into the second water storage tank 12. Then, the water in the second water storage tank 12 falls down onto the water return pipe 13 to impact the catch plates 46 as shown in FIG. 6 so as to rotate the water mill 41 which rotates the larger sprocket 43 which rotates the smaller sprocket 44 via the transmission chain 45 to rotate the screw propeller 42 so that the screw propeller 42 is rotated in the water return pipe 13 as shown in FIG. 5 to thrust the water in the water return pipe 13 into the first water storage tank 11. Thus, the water drained from the water raising device 20 is driven by the water return device 40 and can be returned into the first water storage tank 11.

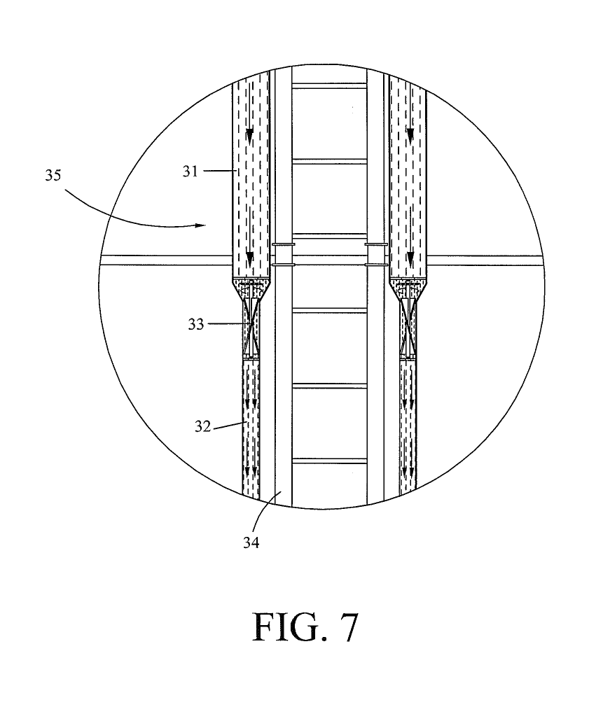

In generating, the water in the water tower 30 flows through the larger pipe 31 into the booster screw 33. Then, the water is pressurized by rotation of the booster screw 33 as shown in FIG. 7, and the pressurized water is delivered into the smaller pipe 32. Then, the pressurized water in the smaller pipe 32 passes through the generator unit 50 and finally falls down into the first water storage tank 11. In such a manner, when the pressurized water passes through the generator unit 50, the generator unit 50 is driven to generate an electric power which is integrated and stabilized to form a steady-state electric power.

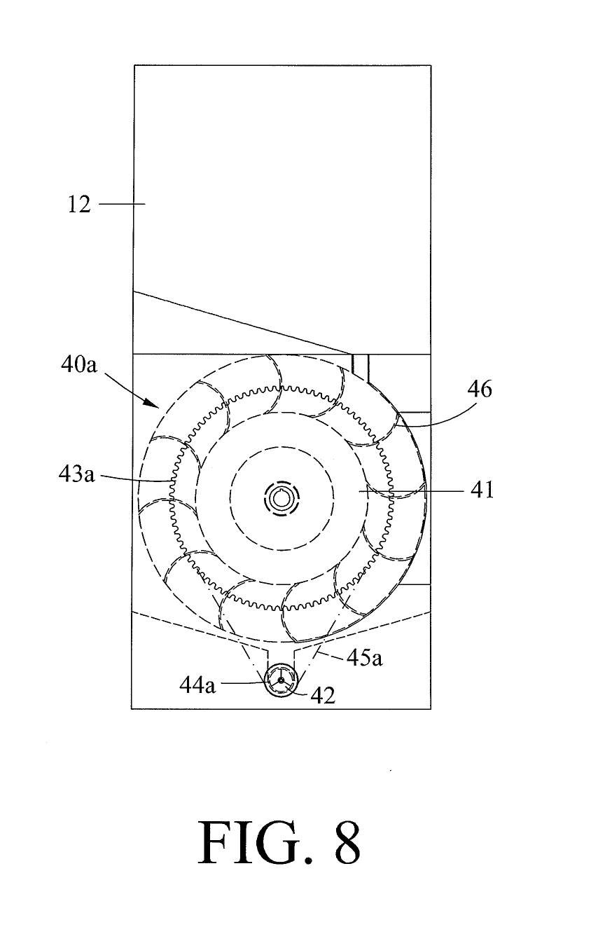

As shown in FIG. 8, the water return device 40a includes a water mill 41 rotatably mounted between the second water storage tank 12 and the water return pipe 13, a screw propeller 42 rotatably mounted in the water return pipe 13 and rotated by the water mill 41 to push the water in the water return pipe 13 toward the first water storage tank 11, a larger belt gear 43a secured on the water mill 41 to rotate in concert with the water mill 41, a smaller belt gear 44a secured on the screw propeller 42 to rotate the screw propeller 42, and a toothed transmission belt 45a mounted between the larger belt gear 43a and the smaller belt gear 44a so that the smaller belt gear 44a is rotated by the larger belt gear 43a.

Accordingly, the pressure tank 26 produces a high air pressure by the successive pivotal action of the air inlet valve 23, and the high air pressure in the pressure tank 26 thrusts the water into the water tower 30 so that the water raising device 20 can pump the water from the first water storage tank 11 into the water tower 30 without needing any electric power so as to save the cost largely. In addition, the water raising device 20 pumps the water from the first water storage tank 11 into the water tower 30, and the water in the water tower 30 initially passes through the generator unit 50 to generate an electric power and then directly falls down into the first water storage tank 11 so that the generating system forms a water cycle to generate an electric power in a cyclic manner. Further, the water drained from the water raising device 20 is driven by the water return device 40 and can be returned into the first water storage tank 11.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A generating system, comprising:
a base;
a first water storage tank mounted on a lower portion of the base;
a water tower mounted on an upper portion of the base;
at least one generator unit mounted on the base and disposed between the water tower and the first water storage tank;
a penstock unit connected between the water tower and the first water storage tank and passing through the generator unit to introduce water from the water tower through the generator unit into the first water storage tank; and
at least one water raising device mounted on a side of the base and connected between the first water storage tank and the water tower to raise water from the first water storage tank to the water tower.

2. The generating system of claim 1, wherein the water raising device includes:
a housing having an inner portion formed with a receiving chamber;
a water inlet pipe having a first end mounted on a first side of the housing and connected to the receiving chamber of the housing and a second end connected to the first water storage tank;
a water outlet pipe mounted on a second side of the housing and connected to the receiving chamber of the housing;
an air inlet valve pivotally mounted in the second side of the housing and located between the water outlet pipe and the receiving chamber of the housing to close a connection between the water outlet pipe and the receiving chamber of the housing;
a weight mounted on the air inlet valve to move the air inlet valve relative to the housing by a gravity of the weight so as to open the connection between the water outlet pipe and the receiving chamber of the housing and to introduce the air from the water outlet pipe into the receiving chamber of the housing;
a pressure tank mounted on a mediate portion of the housing and connected to the receiving chamber of the housing;
a water conveyor pipe having a first end connected to the pressure tank and a second end connected to the water tower to convey water from the pressure tank to the water tower;
a water pump valve movably mounted in the pressure tank and movable between the pressure tank and the housing to open a connection between the pressure tank and the receiving chamber of the housing; and
a restoring spring biased between the water pump valve and the housing to close the water pump valve and to close the connection between the pressure tank and the receiving chamber of the housing.

3. The generating system of claim 2, wherein
the water outlet pipe of the water raising device has a first end mounted on the second side of the housing and connected to the receiving chamber of the housing;
the generating system further comprises:
at least one second water storage tank located under a second end of the water outlet pipe of the water raising device to receive water from the water outlet pipe of the water raising device;
at least one water return pipe connected between the second water storage tank and the first water storage tank to return water from the second water storage tank to the first water storage tank; and
at least one water return device mounted on the water return pipe to pump water from the water return pipe to the first water storage tank;
the water return device is located under the second water storage tank.

4. The generating system of claim 3, wherein
the water return device includes:
a water mill rotatably mounted between the second water storage tank and the water return pipe;
a screw propeller rotatably mounted in the water return pipe and rotated by the water mill to push the water in the water return pipe toward the first water storage tank;
a larger sprocket secured on the water mill to rotate in concert with the water mill;
a smaller sprocket secured on the screw propeller to rotate the screw propeller; and
a transmission chain mounted between the larger sprocket and the smaller sprocket so that the smaller sprocket is rotated by the larger sprocket;
the smaller sprocket of the water return device has a diameter smaller than that of the larger sprocket;
the water mill of the water return device has a periphery provided with a plurality of semi-circular catch plates that are movable to align with the second water storage tank;
the screw propeller of the water return device is located under the water mill.

5. The generating system of claim 3, wherein
the water return device includes:
a water mill rotatably mounted between the second water storage tank and the water return pipe;
a screw propeller rotatably mounted in the water return pipe and rotated by the water mill to push the water in the water return pipe toward the first water storage tank;
a larger belt gear secured on the water mill to rotate in concert with the water mill;
a smaller belt gear secured on the screw propeller to rotate the screw propeller; and
a toothed transmission belt mounted between the larger belt gear and the smaller belt gear so that the smaller belt gear is rotated by the larger belt gear;
the water mill of the water return device has a periphery provided with a plurality of semi-circular catch plates that are movable to align with the second water storage tank;
the screw propeller of the water return device is located under the water mill.

6. The generating system of claim 2, wherein the base 1 includes:
a plurality of delivery pipes each having an upper end connected to the water tower and a lower end connected to the water conveyor pipe of the water raising device; and
a plurality of check valves mounted on the delivery pipes to prevent water in the water tower from flowing back into the water conveyor pipe of the water raising device.

7. The generating system of claim 1, wherein the penstock unit includes:
at least one larger pipe having an upper end connected to the water tower;
at least one smaller pipe having an upper end connected to a lower end of the larger pipe and a lower end passing through the generator unit and connected to the first water storage tank; and
a booster screw rotatably mounted in the smaller pipe to increase pressure of water from the larger pipe into the smaller pipe.

8. The generating system of claim 7, wherein the generating system further comprises a ladder resting on the water tower.

9. The generating system of claim 8, wherein the larger pipe and the smaller pipe of the penstock unit construct a part of the ladder.

10. The generating system of claim 2, wherein the water raising device further includes:
an air inlet port mounted on a periphery of the water outlet pipe to introduce ambient air into the water outlet pipe.

11. The generating system of claim 10, wherein the air inlet port of the water raising device is disposed between the air inlet valve and the water outlet pipe.

12. The generating system of claim 2, wherein the pressure tank of the water raising device is disposed between the water inlet pipe and the air inlet valve.

13. The generating system of claim 2, wherein the air inlet valve of the water raising device is disposed between the pressure tank and the water outlet pipe.

14. The generating system of claim 2, wherein the water pump valve of the water raising device is disposed between the receiving chamber of the housing and the water conveyor pipe.

15. The generating system of claim 3, wherein the water return pipe and the water return device are disposed under the second water storage tank.

16. The generating system of claim 1, wherein
the penstock unit is located under the water tower and above the generator unit and the first water storage tank;
the generator unit is located above the first water storage tank.

17. The generating system of claim 7, wherein
the smaller pipe of the penstock unit has a diameter smaller than that of the larger pipe;
the booster screw of the penstock unit is disposed between the larger pipe and the smaller pipe.
